(19) United States
(12) Patent Application Publication
(10) Pub. No.: US 2024/0409202 A1
(43) Pub. Date: Dec. 12, 2024

(54) Fly by Wire Flight Control System

(71) Applicant: Textron Aviation Inc., Wichita, KS (US)

(72) Inventors: Stephen M. Eddy, Derby, KS (US); Steven G. Hagerott, Wichita, KS (US)

(21) Appl. No.: 18/737,131

(22) Filed: Jun. 7, 2024

Related U.S. Application Data
(60) Provisional application No. 63/506,821, filed on Jun. 7, 2023.
(60) Provisional application No. 63/506,822, filed on Jun. 7, 2023.

(51) Int. Cl. B64C 13/50; B64C 13/04

(52) U.S. Cl. CPC B64C 13/503; B64C 13/04; B64C 13/507

(57) ABSTRACT

A flight control system includes a first and second operator input means configured to receive a mechanical input from an operator and are connected to an artificial feel system and at least one sensor. The system includes a flight control computer (FCC) in data communication with the sensor, wherein the FCC receives a signal from the sensor in response to an input by the operator. The flight control system has first and second servo controllers in data communication with first and second servos, respectively, and the FCC. The servos are connected to control surfaces that, when moved, cause the aircraft to change attitude. The flight control system also includes a third and a fourth servo controller, the third and fourth servo controllers being in communication with the FCC and a dual-lane servo operably connected to a third control surface that, when moved, causes the aircraft to change attitude.

### CROSS-REFERENCE TO RELATED APPLICATIONS

This application claims priority to U.S. Provisional Patent Application No. 63/506,822, filed on Jun. 7, 2023, and U.S. Provisional Patent Application No. 63/506,821, filed on Jun. 7, 2023, the disclosures of which are incorporated herein in their entirety by reference.

### BACKGROUND

### 1. Field

The disclosure relates generally to the field of aviation control systems. More specifically, the disclosure relates to systems and methods for manipulating control surfaces on an aircraft using fly-by-wire (FBW) architectures to aerodynamically control flight characteristics.

### 2. Related Art

Various solutions have been proposed for augmenting an operator's input to improve the control of an aircraft. For example, U.S. Pat. No. 7,840,316 to Yount discloses FBW systems using computers to command actuators controlling flight surfaces. U.S. Pat. No. 9,415,860 to Beaufrere discloses a FBW system using electronic actuators and a force-transduced side stick. U.S. Pat. No. 5,456,428 to Hegg discloses a FBW system in which two or more side sticks are linked. U.S. Patent Application Publication No. 2021/197,958 to Liscouet discloses using electric motors to provide a resistant force to side sticks in order to replicate a mechanical feel in a FBW architecture.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

According to an embodiment, a flight control system for an aircraft having a plurality of aerodynamic control surfaces includes a first and second operator input means configured to receive a mechanical input from an aircraft operator and being connected to an artificial feel system and at least one sensor. The flight control system includes a flight control computing system having a first, a second, and a third flight control computer, with each flight control computer being in data communication with the sensor, wherein the computing system receives a signal from at least one sensor in response to an input by the operator. The flight control system also includes a first servo controller in data communication with a first servo and the flight control computing system, the first servo being operably connected to a first aerodynamic control surface that, when moved, causes the aircraft to change attitude in a first degree of freedom. The flight control system also has a second servo controller in data communication with a second servo and the flight control computing system, the second servo being operably connected to a second aerodynamic control surface that, when moved, causes the aircraft to change attitude in a second degree of freedom. Additionally, the flight control system includes a third servo controller and a fourth servo controller, with the third servo controller and the fourth servo controller being in data communication with a dual-lane servo operably connected to a third aerodynamic control surface that, when moved, causes the aircraft to change attitude in a third degree of freedom.

According to another embodiment, a flight control system for an aircraft having a plurality of aerodynamic control surfaces requires an operator input means configured to receive a mechanical input from an aircraft operator and being connected to at least one sensor. The system has a flight control computing system with a first, a second, and a third flight control computer, each flight control computer being in data communication with the sensor. The computing system receives a signal from the at least one sensor in response to an input by the operator. A first electro-mechanical actuator (EMA) controller is in data communication with a first EMA and the flight control computing system, with the first EMA being operably connected to at least a first portion of a first aerodynamic control surface that, when moved by the first EMA, causes the aircraft to change attitude in a first degree of freedom. The system also includes a second EMA controller in data communication with a second EMA and the flight control computing system, with the second EMA being operably connected to at least a first portion of a second aerodynamic control surface that, when moved by the second EMA, causes the aircraft to change attitude in a second degree of freedom.

According to yet another embodiment, a flight control system for an aircraft having a plurality of aerodynamic control surfaces has an operator input means configured to receive a mechanical input from an aircraft operator and being connected to at least one sensor. The system has a flight control computing system with a first and a second flight control computer, each flight control computer being in data communication with the sensor, wherein the computing system receives a signal from the at least one sensor in response to an input by the operator. The system also includes a first aerodynamic control surface that, when moved, causes the aircraft to change attitude in a first degree of freedom, the first aerodynamic control surface being selectively connected to the operator input means via a first mechanical linkage. Similarly, the system has a second aerodynamic control surface that, when moved, causes the aircraft to change attitude in a second degree of freedom, the second aerodynamic control surface being selectively connected to the operator input means via a second mechanical linkage. The system also includes a first servo controller in data communication with the flight control computing system and a first servo operably connected to the first aerodynamic control surface, with the first servo being configured to selectively move the first aerodynamic control surface in response to a signal from the flight control computing system via the first servo controller. The system also includes a latch-up mechanism configured to selectively engage at least one of the first mechanical linkage and the second mechanical linkage in response to an operator input.

### BRIEF DESCRIPTION OF THE DRAWING FIGURES

Illustrative embodiments of the present disclosure are described in detail below with reference to the attached drawing figures, wherein:

FIG. 1 illustrates a schematic view of an embodiment of a hybrid flight control system having a FBW architecture and a mechanical control path operable via selectively engageable mechanical side sticks;

FIG. 2 illustrates a schematic view of another embodiment of a hybrid flight control system having additional control surfaces compared to the flight control system of FIG. 1;

FIG. 3 illustrates a schematic view of yet another embodiment of a hybrid flight control system having a FBW architecture and a mechanical control path operable via selectively engageable mechanical side sticks;

FIG. 4 illustrates a schematic view of another embodiment of a hybrid flight control system having additional control surfaces compared to the flight control system of FIG. 3;

FIG. 5 illustrates a schematic view of an embodiment of a flight control system utilizing a FBW architecture to manipulate various control surfaces.

FIG. 6 illustrates a schematic view of another embodiment of a flight control system utilizing a FBW architecture, with additional control surfaces compared to the control system of FIG. 5.

FIG. 7 illustrates a schematic view of yet another embodiment of a flight control system utilizing a FBW architecture to manipulate various control surfaces.

FIG. 8 illustrates a schematic view of still a further embodiment of a flight control system utilizing a FBW architecture, with additional control surfaces compared to the control system of FIG. 7.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Typically, the flight characteristics of an aircraft are controlled by a number of moveable aerodynamic surfaces on the wing and tail of the aircraft which can be manipulated to control the desired pitch, roll, and yaw. Smaller aircraft may use simple mechanical linkages to transmit a pilot's control inputs to these aerodynamic surfaces, while larger and/or faster aircraft may use power-assisted or fully-powered control systems. These powered control systems may use mechanical linkages as well as “fly-by-wire” (FBW) systems, which utilize a computerized command and a feedback loop. The FBW systems may be used in conjunction with the mechanical linkages, or some control systems may use FBW systems instead of mechanical linkages for certain elements.

Augmenting mechanical systems with fly-by-wire systems and/or other assistance systems may provide numerous advantages. While manually operated or fully mechanical control systems may provide a direct and reliable link between the operator's inputs and the subsequent behavior of the control surfaces, manual systems may have specific failure modes that require redundant, independent load paths to ensure continued safe operation of the aircraft. With manual systems, the work available at the control surface(s) is directly related to (and therefore limited by) the force and/or travel that an operator can apply to the cockpit controls. As the speed and size of the aircraft increases, it can become increasingly difficult for a pilot to effectively control the aircraft, since the required force to activate the control surfaces also increases due to increased aerodynamic load. This is especially true when a side stick or a center stick is used as the pilot input device rather than a control wheel due to the shorter moment arm of a side stick. It therefore may be advantageous for a control system to provide additional assistance or “boost” to the operator's input to achieve the desired flight characteristics or indeed to utilize a fully electronic or FBW architecture which is not subject to the same input limitations. Additionally, it may be advantageous for a primarily FBW control system to include a parallel mechanical control path which can be utilized in the event of any combination of failures that result in a loss of the primary FBW system. Another advantage of a “hybrid” flight control system having both FBW and mechanical control paths is that hybrid control systems may reduce mass and cost compared to full FBW control systems.

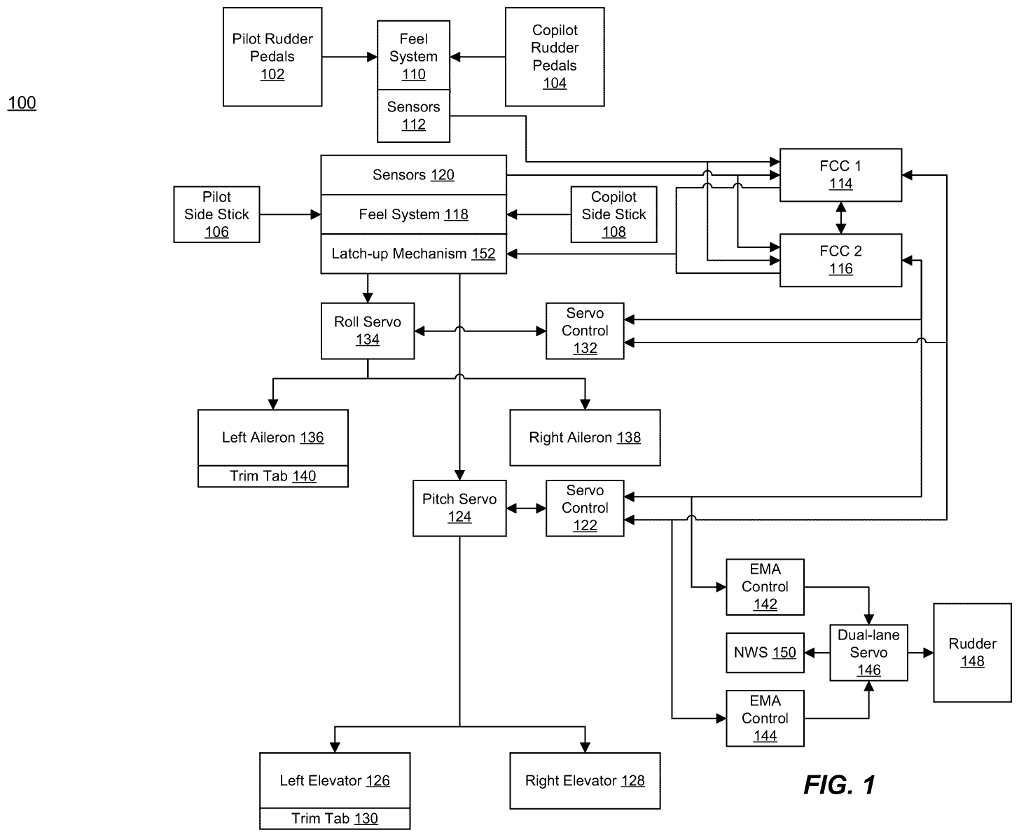

FIG. 1 shows a schematic view of a first embodiment of a flight control system 100. The flight control system 100 uses one or more operator control inputs, such as pilot and copilot rudder pedals 102 and 104, pilot and copilot side sticks 106 and 108, respectively, to control aerodynamic control surfaces (such as ailerons or elevators) of an aircraft in order to achieve a desired flight characteristic. The flight control system 100 may be referred to as a “hybrid” flight control system, because it employs both a traditional mechanical control paths as well as a FBW control path. In some embodiments, the flight control system may be configured such the aircraft is controlled via the FBW control path during normal operation, and the mechanical control path may be selectively engaged only when needed; for example, in the event of a failure of a component in the FBW control path. The flight control system 100 described herein may be most applicable to single- or twin-engine Class I or II aircraft. These aircraft may include dual air data computers (ADCs) and dual inertial reference systems, although it may not be necessary to include more than one generator for powering the various FBW components. However, flight control system 100 is not necessarily limited to these kinds of aircraft, and may be employed on any number of aircraft without departing from the scope of the invention.

When the FBW control path is utilized, the operator control inputs 102-108 may not be mechanically connected to the control surfaces. In order to provide tactile feedback as a mechanical connection or linkage would, the pilot and copilot rudder pedals 102 and 104, respectively, are connected to an artificial feel system 110. This artificial feel system 110 is configured to provide realistic tactile or haptic feedback to the operator(s), which indicate the behavior of the aircraft to the operator in a similar fashion to a traditional mechanical linkage. In addition to the rudder pedal feel system 110, the pilot and copilot pedals 102, 104 are operatively connected to one or more sensors 112. The sensors 112, for example a position sensor which detects the relative or angular position of the pedals 102 and 104, are in data communication with one or more flight control computers 114 and 116. These sensors send a signal (such as a position signal indicating the position or change in position of the pedals) to the computers 114 and 116, which can be further relayed to the various control surfaces.

In addition to sensors 112, flight control computers 114 and 116 may receive data from a variety of sensors onboard the aircraft as further described below. These include but are not limited to sensors for providing air data, inertial data, angle of attack data, control surface position, and pilot inceptor position. Sensor data may be provided in duplicate via redundant sensors as needed to meet integrity and availability requirements as appropriate to each architectural variation described herein.

Similar to the rudder pedals 102 and 104, the pilot and copilot side sticks 106 and 108, respectively, may also be mechanically disconnected from the FBW system during normal operation. As a result, the side sticks 106 and 108 are also coupled to an artificial feel system 118 which is configured to provide feedback to the operator(s) when the FBW control path is used. The side sticks 106 and 108 may be mechanically interconnected, such that they move in concert during operation of the aircraft. In some embodiments, the interconnected side sticks 106 and 108, as well as the central feel system 118, may be similar to the side sticks and feel system disclosed in U.S. Pat. No. 11,014,648 to Eddy et al., the disclosure of which is incorporated herein, in its entirety, by reference. In addition to the feel system 118, the side sticks 106 and 108 are operatively connected to one or more sensors 120, similar to the rudder pedals 102 and 104. The sensors 120, which may include for example a position sensor, are in data communication with the flight control computers 114 and 116. These sensors 120 send a signal (such as a position signal indicating the position or change in position of the side sticks in one or more axes) to the computers 114 and 116, which can be further relayed to the various control surfaces.

As noted above, the flight control system 100 includes a first and second flight control computer 114 and 116, respectively, which are in data communication with the operator control inputs. In the illustrated embodiment, there are two flight control computers, although in other embodiments not shown the flight control system 100 may employ more than two computers in order to add additional redundancy to the system, without departing from the scope of the invention. The flight control computers 114 and 116 may be single-lane, for example in a command-monitor arrangement, or dual-lane, for example in a primary-backup arrangement, depending on the application. Flight control computers 114 and 116 are in data communication with a plurality of servo controllers or other electronic control systems forming part of the overall flight control system 100.

The first and second flight control computer 114 and 116 provide surface position commands to control electronics that in turn generate commands to a servo actuator or electromechanical actuator (EMA) that moves the flight control surface(s) to the commanded position based on actuator/servo position feedback in conjunction with closed loop position control algorithms within the motor or servo electronics. For example, each controller controls or is in data communication with a servo or electro-mechanical actuator (EMA), which is operatively connected to one or more aircraft control surfaces, and is configured to position the control surface(s) in order to achieve the desired pitch, roll, and yaw of the aircraft. Each servo or EMA described herein may be attached directly to a flight control surface or may be connected to the flight control surface indirectly via push-rods, torque tubes, flex shafts, cables, or other mechanical means. Additionally, any of the EMAs described herein may be replaced with hydraulic actuator without departing from the scope hereof.

For controlling the pitch of the aircraft, the first and second flight control computers 114 and 116 are in data communication with a pitch servo controller 122. The pitch servo controller 122 is in data communication with a pitch servo 124, which is mechanically and operatively connected to the left-hand and right-hand elevators 126 and 128. Upon receiving an input signal indicating an operator's desire to change the pitch of the aircraft (via side sticks 106 and 108, for example), the flight control computers 114 and 116 each send a signal to the pitch servo controller 122, which in turn activates the pitch servo 124 accordingly to raise or lower one or both of the elevators 126 and 128. As the pitch servo 124 is moving the elevator(s), the pitch servo controller 122 relays the position and/or other relevant data about the pitch servo 124 back to the flight control computers 114 and 116. The left and/or right-hand elevator may include an additional trim tab 130 which may be operated via traditional control means.

For controlling the roll of the aircraft, the flight control computers 114 and 116 are in data communication with a roll servo controller 132. The roll servo controller 132 is in data communication with a roll servo 134, which is mechanically and operatively connected to the left-hand and right-hand ailerons 136 and 138. Upon receiving a signal indicating an operator's desire to change the roll of the aircraft (via side sticks 106 and 108, for example), the flight control computers 114 and 116 each send a signal to the roll servo controller 132, which in turn activates the roll servo 134 accordingly to raise or lower one or both of the ailerons 136 and 138. As the roll servo 134 is moving the aileron(s), the roll servo controller 132 relays the position and/or other relevant data about the roll servo 134 back to the flight control computers 114 and 116. Similar to the elevators, the left and/or right-hand aileron may include an additional trim tab 140 which may be operated via traditional control means.

For yaw control, the flight control computers 114 and 116 are in data communication with at least one EMA controller 142. In some embodiments, such as the illustrated embodiment, the computers 114, 116 are in communication with two EMA controllers 142 and 144. Both of these controllers 142 and 144 are in data communication with a dual-lane single motor EMA or servo 146, which is operatively connected to both the rudder 148 and the nose wheel steering (NWS) assembly 150. Upon receiving a signal indicating an operator's desire to change the yaw angle of the aircraft (for example, via the rudder pedals 102 and 104 and sensors 112), the flight control computers 114 and 116 each send a signal to the EMA controllers 142 and 144, which in turn activates the dual-lane servo 146 accordingly to adjust the position of the rudder 148 and/or move the nose wheel steering assembly 150 accordingly. As the dual-lane servo 146 is moving the rudder 148 and/or the nose wheel steering assembly 150, the EMA controllers 142 and 144 relay the position and/or other relevant data about the dual-lane servo 146 back to the flight control computers 114 and 116.

In the event of a component failure in the FBW control path, the flight control system 100 includes a mechanical latch-up mechanism 152, which enables the aircraft to be controlled manually through mechanical linkages, rather than the FBW system. This latch-up mechanism 152 may be mechanically biased, such as with a spring, towards an engaged state but remains unlatched when the FBW control path is used and operating normally. When a failure is detected or it is determined that one or both of the flight control computers 114 and 116 have been compromised, a solenoid is triggered, which releases the spring or biasing member. This forces the side sticks 106 and 108 into mechanical alignment with the flight control system and the various control surfaces. The latch-up mechanism 152 may also include a damper which prevents or limits abrupt motion of the side sticks 106 and 108 during the latching-up process. In some embodiments, the artificial feel system 118 may be simultaneously or subsequently disconnected from the side sticks 106 and 108 in order to remove unwanted artificial feedback to the operator.

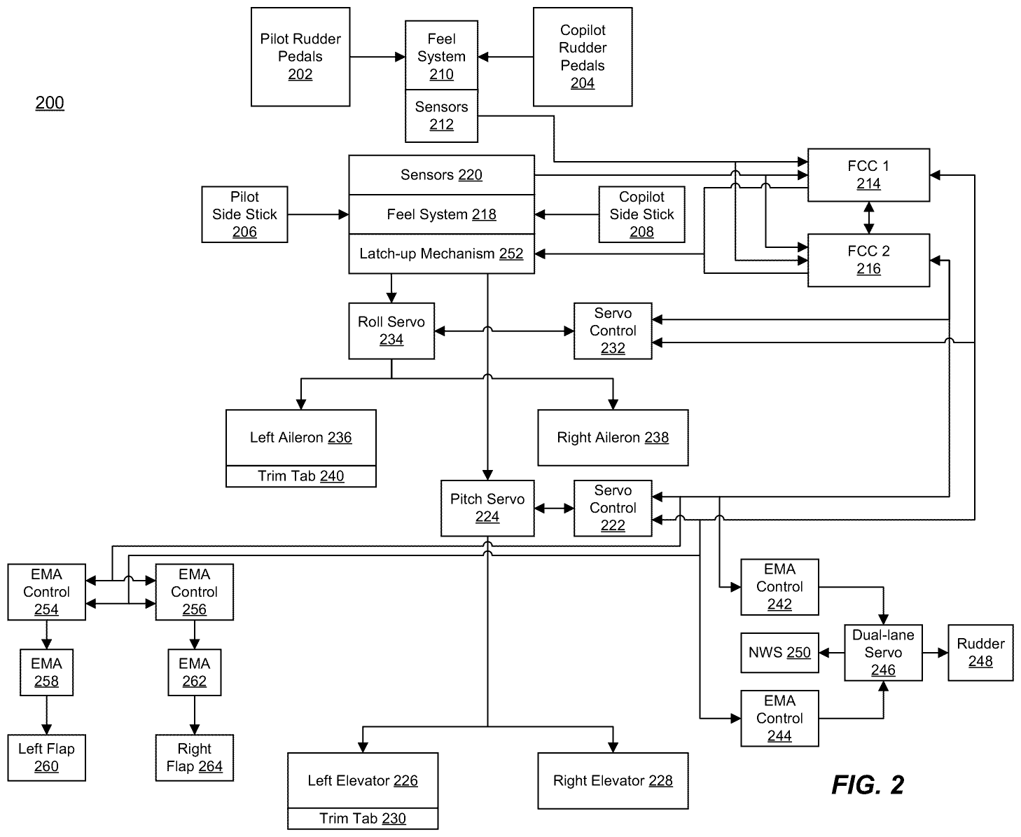

Referring now to FIG. 2, a schematic view of another embodiment of a flight control system 200 is shown. The flight control system 200 is similar to the flight control system 100 shown in FIG. 1, although flight control system 200 contains additional control surfaces compared to flight control system 100. For the sake of uniformity and brevity, reference numerals 200-299 correspond generally to the embodiment shown in FIG. 2, and correlate generally to reference numerals 100-199 (for example, pilot and copilot side sticks 206 and 208 correspond to pilot and copilot side sticks 106 and 108, pitch servo 224 corresponds to pitch servo 124, etc.), except where shown, described, or otherwise inherent.

In addition to the features shown and described in flight control system 100, flight control system 200 includes additional control surfaces as part of the FBW control path which perform functions beyond simply controlling the pitch, roll, and yaw of the aircraft. The first and second flight control computers 214 and 216 are in data communication with EMA controllers 254 and 256. EMA controller 254 is in data communication with EMA 258, which is operatively connected to the left-hand flap(s) 260 of the aircraft. Similarly, EMA controller 256 is in data communication with the EMA 262, which is operatively connected to the right-hand flap(s) 264 of the aircraft. Upon receiving input from the operator (via the operator control inputs or otherwise), the computers 214 and 216 each send a signal to the EMA controllers 254 and 256, which then activate the EMAs 258 and 262 accordingly. For example, the flap panels 260 and 264 may be independently or symmetrically operated for lift-dumping or turbulence rejection.

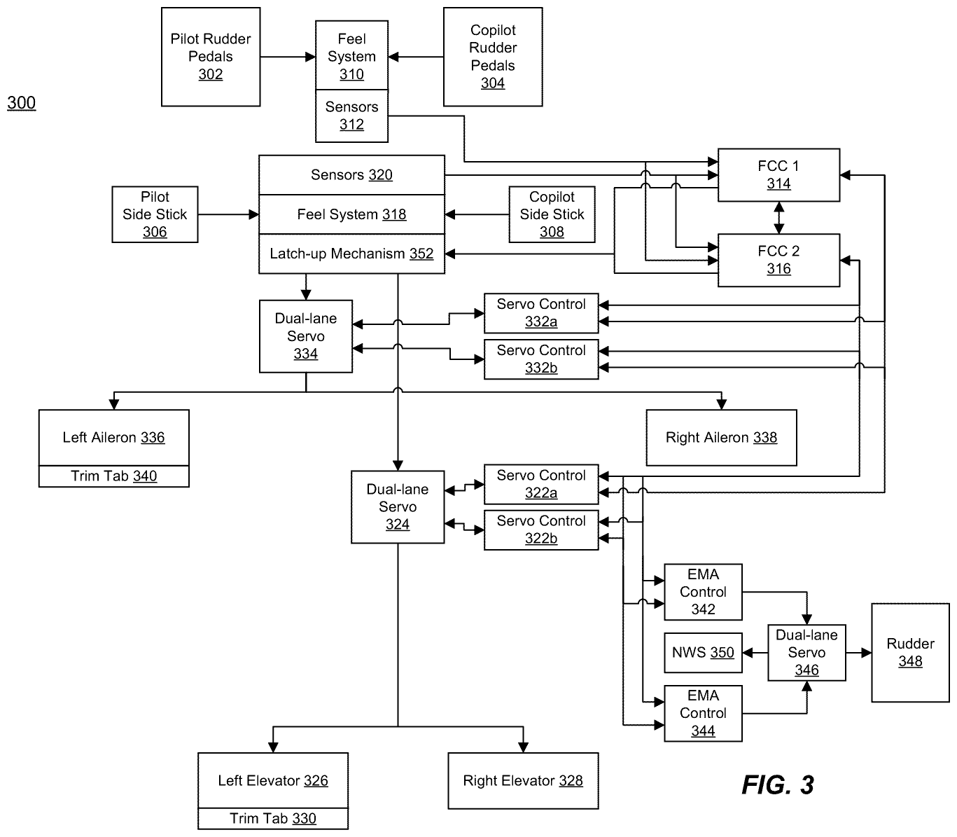

FIG. 3 shows a schematic of another embodiment of a flight control system 300. The flight control system 300 is similar to the flight control system 100 shown in FIG. 1, except where otherwise noted below. For the sake of uniformity and brevity, reference numerals 300-399 correspond generally to the embodiment shown in FIG. 3, and correlate generally to reference numerals 100-199 (for example, pilot and copilot side sticks 306 and 308 correspond to pilot and copilot side sticks 106 and 108, left elevator 326 corresponds to left elevator 126, etc.), except where shown, described, or otherwise inherent.

Compared to flight control system 100, flight control system 300 may be best suited for use with Class III or IV aircraft having a single or twin turboprop or jet propulsion configuration. These aircraft may include dual air data computers (ADCs) and dual inertial reference systems, although it may not be necessary to include more than one generator for powering the various FBW components. However, flight control system 300 is not necessarily limited to these kinds of aircraft, and may be employed on any number of aircraft without departing from the scope of the invention.

Rather than a single pitch servo controller and a single roll servo controller as in the flight control system of FIG. 1, the flight control system 300 uses a pair of servo controllers for each axis of control. In some embodiments, for controlling the pitch the first and second flight control computers 314 and 316 are each in two-way data communication with a first pitch servo controller 322a and a second pitch servo controller 322b. In some embodiments, the flight control computers (FCCs) 316 and 318 may be in an “active-active” arrangement, wherein both are used simultaneously, while in other embodiments computers 316 and 318 may be in an “active-standby” arrangement, wherein one computer is used as the primary control computer, while the second computer (or further subsequent FCCs) serves primarily as a backup.

The pitch servo controllers 322a and 322b are both in data communication with a single dual-lane (e.g., a single drive train with two motors) pitch servo 324, which is operatively connected to the left and right elevators 326 and 328, respectively. As the dual-lane pitch servo 324 moves the elevator(s), the pitch servo controllers 322a and 322b relay the position and/or other relevant data about the dual-lane pitch servo 324 and/or the elevators 326 and 328 back to the flight control computers 314 and 316. The left and/or right-hand elevator may include an additional trim tab 330 which may be operated via traditional control means.

Similarly, for controlling the roll, the first and second flight control computers 314 and 316 are each in two-way data communication with a first roll servo controller 332a and a second roll servo controller 332b. The roll servo controllers 332a and 332b are both in data communication with a single dual-lane roll servo 334, which is operatively connected to the left and right ailerons 336 and 338, respectively. As the dual-lane roll servo 334 moves the aileron(s), the roll servo controllers 332a and 332b relay the position and/or other relevant data about the dual-lane roll servo 334 and/or the ailerons 336 and 338 back to the flight control computers 314 and 316. The left and/or right-hand aileron may include an additional trim tab 340 which may be operated via traditional control means.

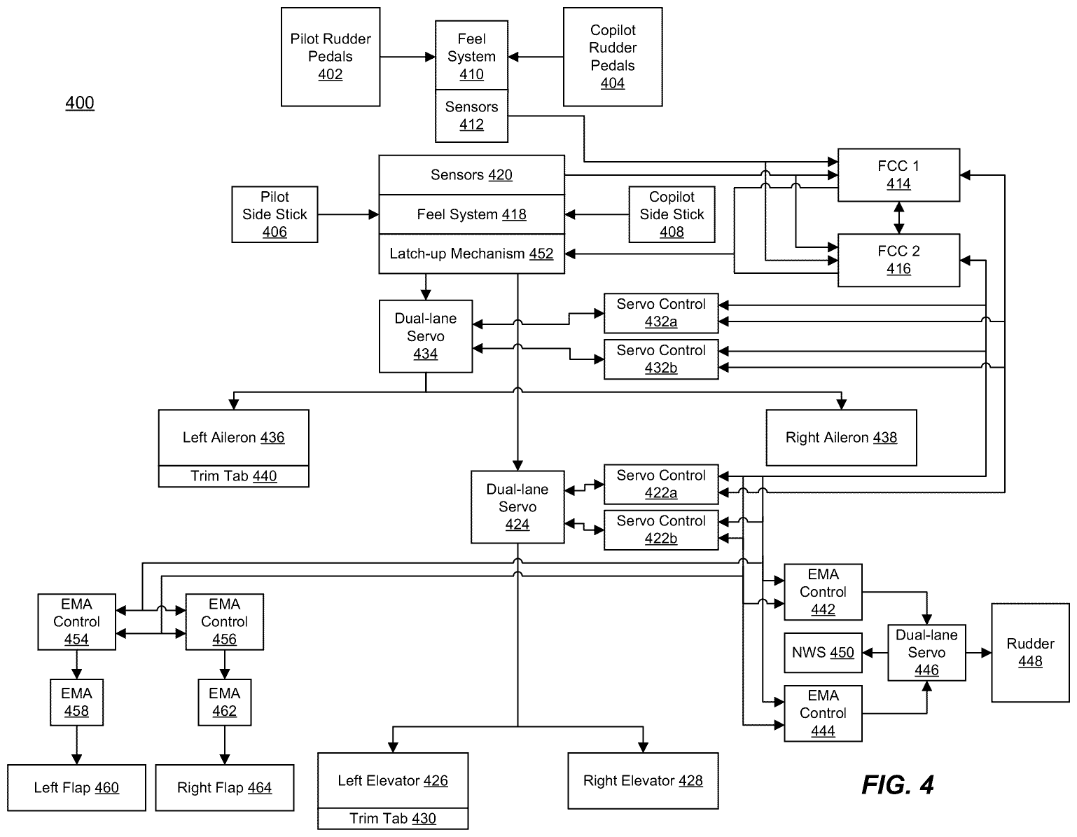

Referring now to FIG. 4, a schematic view of another embodiment of a flight control system 400 is shown. The flight control system 400 is similar to the flight control system 300 shown in FIG. 3, although flight control system 400 contains additional control surfaces compared to flight control system 300. For the sake of uniformity and brevity, reference numerals 400-499 correspond generally to the embodiment shown in FIG. 4, and correlate generally to reference numerals 300-399 (for example, pilot and copilot side sticks 406 and 408 correspond to pilot and copilot side sticks 406 and 408, dual-lane pitch servo 424 corresponds to dual-lane pitch servo 324, etc.), except where shown, described, or otherwise inherent.

In addition to the features shown and described in flight control system 300, flight control system 400 includes additional control surfaces as part of the FBW control path which perform functions beyond simply controlling the pitch, roll, and yaw of the aircraft. The first and second flight control computers 414 and 416 are in data communication with EMA controllers 454 and 456. EMA controller 454 is in data communication with EMA 458, which is operatively connected to the left-hand flap(s) 460 of the aircraft. Similarly, EMA controller 456 is in data communication with the EMA 462, which is operatively connected to the right-hand flap(s) 464 of the aircraft. Upon receiving input from the operator (via the operator control inputs or otherwise), the computers 414 and 416 each send a signal to the EMA controllers 454 and 456, which then activates the EMAs 458 and 462 accordingly. For example, the flap panels 460 and 464 may be independently or symmetrically operated for lift-dumping or turbulence rejection.

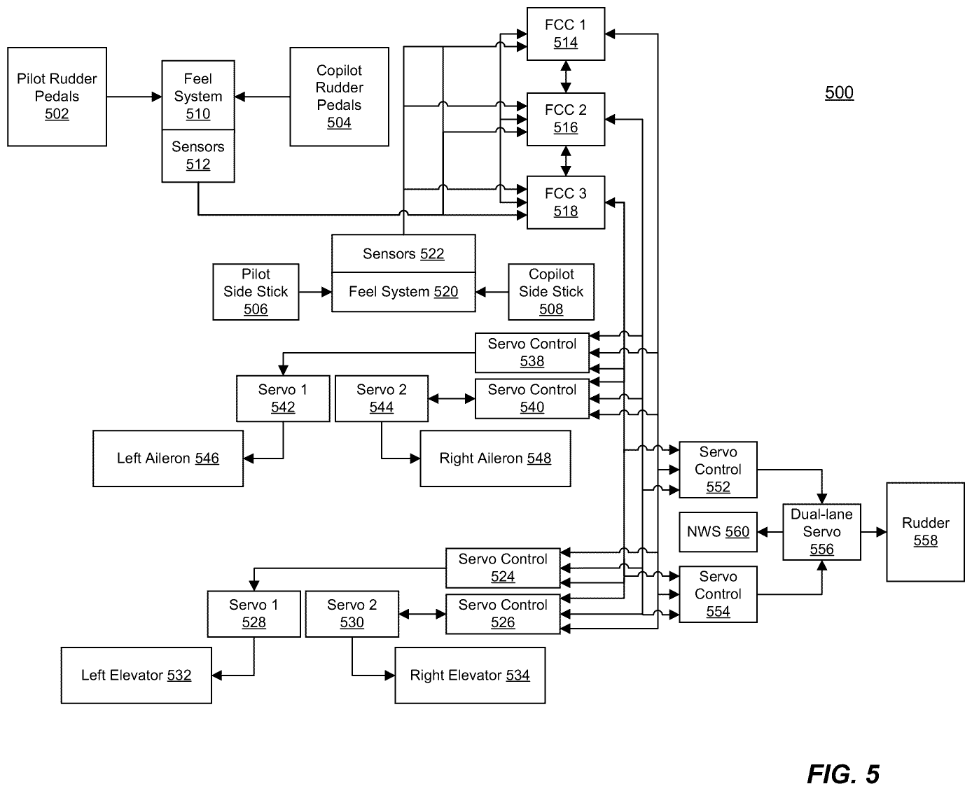

Referring now to FIG. 5, a schematic view of a fly-by-wire flight control system 500 is shown. Unlike the embodiments shown and described in FIGS. 1-4, the FBW flight control system 500 does not include a mechanical connection between the operator input controls and the flight control surfaces. The operator input controls, such as pilot and copilot rudder pedals 502 and 504, as well as pilot and copilot side sticks 506 and 508, are instead connected to an artificial feel system to provide feedback to the operator(s), and via sensors they are in data communication with multiple flight control computers which electronically transmit inputs to the various control surfaces. The flight control system 500 allows for flight augmentation without providing feedback to the side sticks.

The flight control system 500 may be most suitable for implementation with Class I or II aircraft having single or twin piston engines. These aircraft may include dual air ADCs and inertial reference systems, as well as means for power generation for providing power to the various FBW components. The power generation may be in the form of one or more generators, and include a battery for power storage, wherein the battery is preferably sized to provide sufficient flight control for a glide-down descent after total loss of engine power. In other embodiments, power generation may be in the form of a ram air turbine or other suitable means known in the art. In the event of a total loss of engine power, the battery may provide power to limited FCCs and control channels to reduce the power draw under the engine failure condition. However, flight control system 500 is not necessarily limited to these kinds of aircraft, and may be employed on any number of aircraft without departing from the scope of the invention.

The pilot and copilot rudder pedals 502 and 504 are connected via an artificial feel system 510, which is configured to provide feedback and/or a resistive force to the operator(s) which corresponds to the current flight characteristics. The rudder pedals 502 and 504 are also connected to one or more sensors 512 (such as an angular position sensor, for example) for determining a characteristic of the pedals and/or detecting an input from the operator(s). The sensors 512 are in data communication with a plurality of flight control computers, and are configured to send a signal corresponding to the operator's inputs to each of the first, second, and third flight control computers 514, 516, and 518. Although the illustrated embodiment shows and uses three flight control computers, in other embodiments not shown there may be any number of flight control computers used, without departing from the scope of the invention.

In embodiments, first, second, and third flight control computers 514, 516, and 518 are arranged in a triplex configuration utilizing three communication lanes that are of common design and perform the control functions and monitor functions. Each lane monitors the other two lanes to ensure agreements. If any single lane is in disagreement with the other two lanes that are in agreement, the lane in disagreement is voted out and no longer used.

In some embodiments, a dual-dual configuration utilizes two channels, with each channel consisting of two lanes, with one lane for system control, and the other lane for monitoring of the control lane. In certain embodiments, a duplex configuration utilizing two channels of common design perform the control functions and monitor functions, in which each channel monitors each other for malfunction. If any single channel is in disagreement with the other channel, both channels are disabled and no longer used. In other embodiments, a single-dual configuration utilizes one channel having two lanes, with one lane for system control and the other lane for monitoring of the control lane.

Similar to the rudder pedals 502 and 504, the pilot and copilot side sticks 506 and 508, respectively, are connected to an artificial feel system 520, which is configured to provide feedback to the operator(s). The side sticks 506 and 508 may be mechanically interconnected, such that they move in concert during operation of the aircraft. In some embodiments, the interconnected side sticks 506 and 508, as well as the central feel system 520, may be similar to the side sticks and feel system disclosed in U.S. Pat. No. 11,014,648 to Eddy et al., the disclosure of which is incorporated herein, in its entirety, by reference. In addition to the feel system 520, the side sticks 506 and 508 are operatively connected to one or more sensors 522, similar to the rudder pedals 502 and 504. The sensors 522, which may include for example a position sensor, are in data communication with the flight control computers 514, 516, and 518. These sensors 522 send a signal (such as a position signal indicating the position or change in position of the side sticks in one or more axes) to the computers 514, 516, and 518, which can be further relayed to the various control surfaces.

The first, second, and third flight control computers (FCCs) are each in data communication with a plurality of electronic controllers for controlling the attitude of the aircraft, such as the pitch, roll, and yaw. Each controller controls or is in data communication with a servo or EMA which is operatively connected to one or more aircraft control surface, and is configured to position the control surface(s) in order to achieve the desired pitch, roll, and yaw response.

For controlling the pitch of the aircraft, the FCCs 514, 516, and 518 are each in communication with at least one of two pitch servo controllers 524 and 526. For redundancy purposes, preferably the FCCs and pitch servo controllers are configured such that all FCCs 514-518 are in data communication with both pitch servo controllers 524 and 526. Therefore, if one of the FCCs fails, there is at least one (and preferably two) remaining FCC which is in data communication with each pitch servo controller 524 and 526. The first pitch servo controller 524 is in data communication with a first pitch servo 528, and the second pitch servo controller 526 is in data communication with a second pitch servo 530. The first pitch servo 528 and the second pitch servo 530 are operatively connected to the left-hand and right-hand elevators 532 and 534, respectively. As the pitch servos 528 and 530 move the elevator(s), the pitch servo controllers 524 and 526 relay the position and/or other relevant data about the pitch servos 528 and 530 back to the flight control computers 514, 516, and/or 518. In some embodiments, the left and right-hand elevators 532 and 534 may be optionally interconnected either electronically or mechanically via a mechanical linkage.

For roll control, the FCCs 514, 516, and 518 are each in communication with at least one of two roll servo controllers 538 and 540. For redundancy purposes, preferably the FCCs and roll servo controllers are configured such that all FCCs 514-518 are in data communication with both roll servo controllers 538 and 540. Therefore, if one of the FCCs fails, there is at least one (preferably two) remaining FCC which is in data communication with each roll servo controller 538 and 540. The first roll servo controller 538 is in data communication with a first roll servo 542, and the second roll servo controller 540 is in data communication with a second roll servo 544. The first roll servo 542 and the second roll servo 544 are operatively connected to the left-hand and right-hand ailerons 546 and 548, respectively. As the roll servos 542 and 544 move the aileron(s), the roll servo controllers 538 and 540 relay the position and/or other relevant data about the roll servos 542 and 544 back to the flight control computers 514, 516, and/or 518. In some embodiments, the left and right-hand ailerons 546 and 548 may be optionally interconnected either electronically or mechanically via a mechanical linkage. In some embodiments, the ailerons 546 and 548 may be able to be decoupled, allowing them to act as “flaperons” for additional flight control. This includes using them as lift augmentation devices, lift dump devices during landing, and symmetric lift augmentation for gust rejection and to improve ride comfort.

For yaw control, FCCs 514, 516, and 518 are each in data communication with at least one yaw servo controllers 552 and 554. Again, for redundancy purposes the FCCs and servo controllers are configured such that all FCCs 514-518 are in data communication with both yaw servo controllers 552 and 554. Therefore, if one of the FCCs fails, there is still at least one FCC in data communication with each yaw servo controller 552 and 554. Both yaw servo controllers 552 and 554 are in data communication with a dual-lane, dual-motor single servo 556 which controls and is operably connected to both the rudder 558 and the nose wheel steering assembly 560. In some embodiments, the nose wheel steering 560 and the rudder 558 are mechanically interconnected.

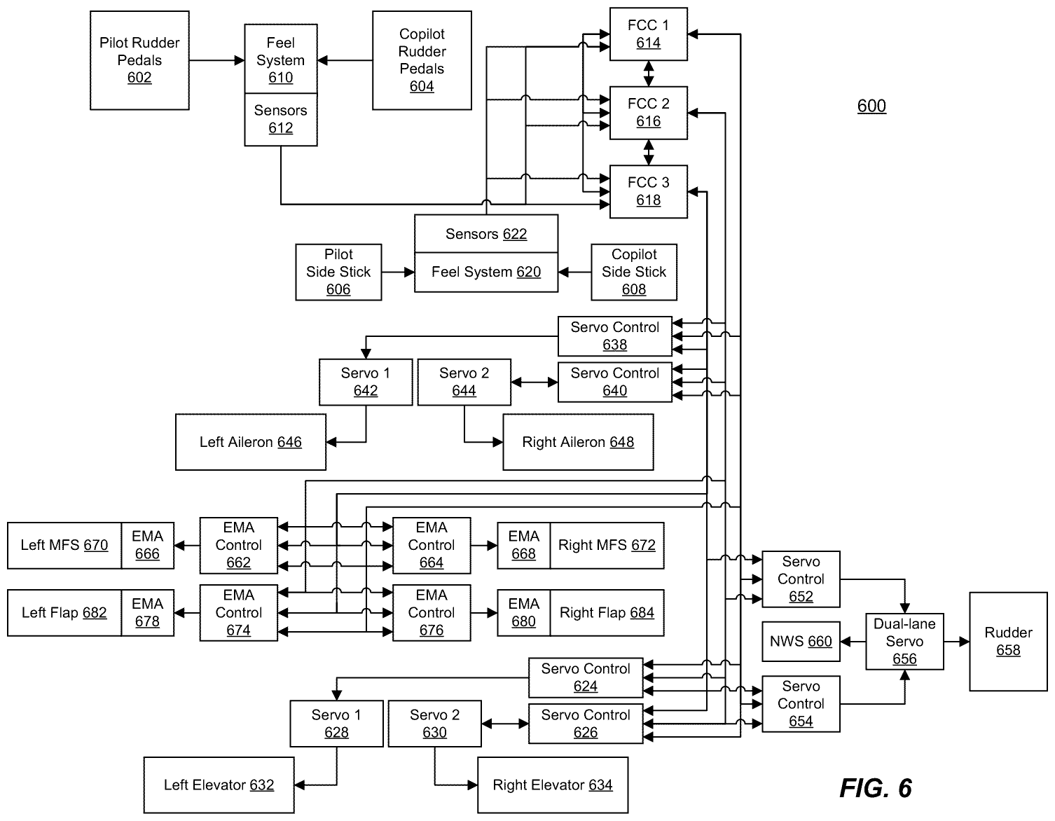

Referring now to FIG. 6, a schematic view of another embodiment of a fly-by-wire flight control system 600 is shown. The flight control system 600 is similar to the flight control system 500 shown in FIG. 5, although flight control system 600 contains additional control surfaces compared to flight control system 500. For the sake of uniformity and brevity, reference numerals 600-699 correspond generally to the embodiment shown in FIG. 6, and correlate generally to reference numerals 500-599 (for example, pilot and copilot side sticks 606 and 608 correspond to pilot and copilot side sticks 506 and 508, first pitch servo 628 and second pitch servo 630 corresponds to first and second pitch servos 528 and 530, respectively, etc.), except where shown, described, or otherwise inherent.

In addition to the features shown and described in flight control system 500, flight control system 600 includes additional control surfaces as part of the FBW control path which perform functions beyond simply controlling the pitch, roll, and yaw of the aircraft, such as multi-function spoilers (MFSs) and flaps. For example, an operator may use MFSs for roll augmentation, in-flight drag devices, and/or as ground spoilers. Similar to the control path for the elevators and the ailerons, each FCC 614, 616, and 618 is connected to at least one MFS EMA controller 662 and 664. For redundancy purposes, each FCC 614-618 is in data communication with both MFS EMA controllers 662 and 664. Therefore, if one of the FCCs fails, there is still at least one FCC in data communication with each MFS EMA controller. The first MFS EMA controller is in data communication with a first MFS EMA 666, and the second MFS EMA controller 664 is connected to and in data communication with a second MFS EMA 668. The first MFS EMA 666 is operably connected to a left hand MFS 670, and the second MFS EMA is connected to a right hand MFS 672. Each MFS EMA 666, 668 is configured to move the left or right hand MFS 670 or 672 in response to receiving a signal from the first or second speedbrake EMA controller 662 or 664, each of which receives a signal from at least two of the FCCs 614-618 in response to an operator input.

In addition to MFSs and general pitch, roll, and yaw, an operator may deploy flaps for lift dumping or turbulence rejection. Similar to the FBW speedbrakes, the flight control system 600 may further include FBW flaps. Each of the FCCs 614, 616, and 618 may be connected to and in data communication with at least one of two flap EMA controllers 674 and 676. Again, for redundancy purposes, only the second FCC 616 is in data communication with both the first flap EMA controller 674 and the second flap EMA controller 676. The first FCC 614 is in data communication with the second flap EMA controller 676, while the third FCC 618 is in data communication with the first flap EMA controller. The first flap EMA controller is in data communication with and connected to a first flap EMA 678, while the second flap EMA controller 676 is in data communication with and connected to a second flap EMA 680. The first flap EMA is then operably connected to the left-hand flap 682 and the second flap EMA is operably connected to the right-hand flap 684. Upon receiving a signal from the sensors 612 or 622 in response to an input from an operator (via the operator input controls or otherwise), the FCCs 614-618 send a signal to the flap EMA controller 674 and 676, which then adjust the left-hand or right-hand flaps 682 and/or 684 via the EMAs 678 and 680.

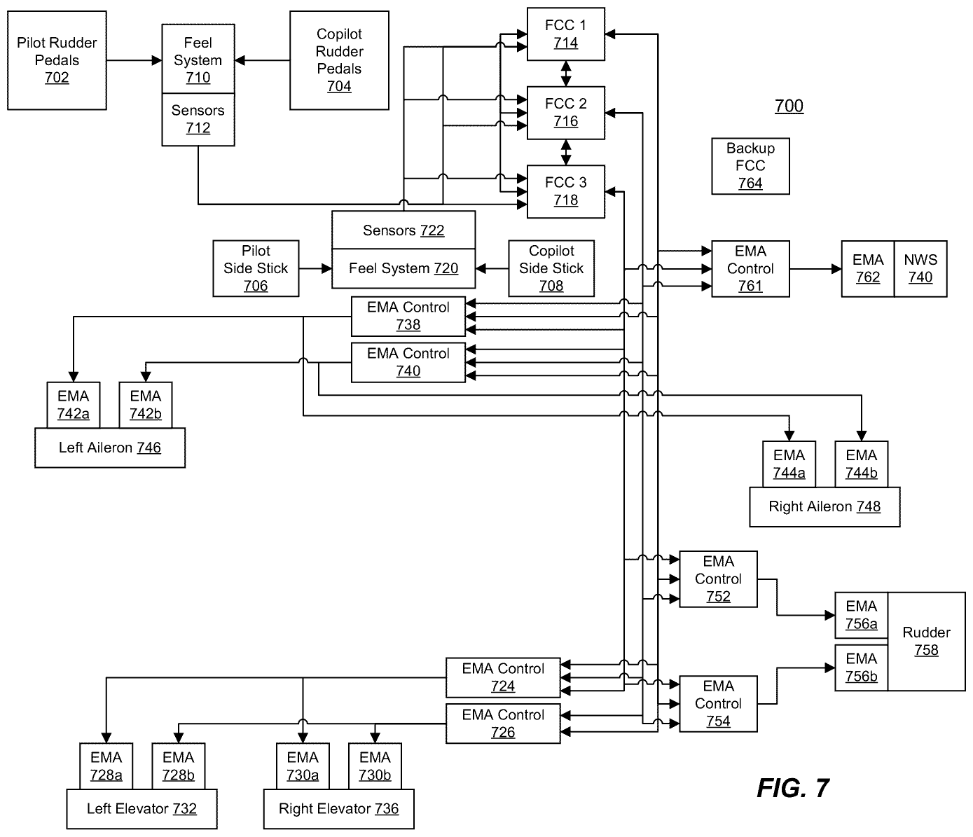

FIG. 7 shows another embodiment of a FBW flight control system 700. The flight control system 700 is similar to the flight control system 500 shown in FIG. 5, except where otherwise noted below. For the sake of uniformity and brevity, reference numerals 700-799 correspond generally to the embodiment shown in FIG. 7, and correlate generally to reference numerals 500-599 (for example, pilot and copilot side sticks 706 and 708 correspond to pilot and copilot side sticks 506 and 508, left elevator 732 corresponds to left elevator 532, etc.), except where shown, described, or otherwise inherent.

Compared to flight control system 500, flight control system 700 may be best suited for use with Class III or IV aircraft having a single or twin turboprop or jet propulsion configuration. These aircraft may include triple air data computers (ADCs) and triple inertial reference systems, as well as means for power generation for providing power to the various FBW components. The power generation may be in the form of one or more generators, and include a battery for power storage, wherein the battery is preferably sized to provide sufficient flight control for a descent after total loss of engine power. In other embodiments, power generation may be in the form of a ram air turbine or other suitable means known in the art. In the event of a loss of engine power, the battery may provide power to limited FCCs and control channels to reduce the power draw under the engine failure condition. However, flight control system 700 is not necessarily limited to these kinds of aircraft and may be employed on any number of aircraft without departing from the scope of the invention.

Compared to FBW flight control system 500, the embodiment shown in FIG. 7 uses a pair of EMAs for actuation of the primary control surfaces rather than a single servo for each surface, in order to build in redundancy and therefore additional failure tolerance. Additionally, using dual EMAs for each control surface allows for surface flutter damping and removal of balance weights. For the elevators and ailerons, the connections between the operator inputs, FCCs, and EMA controllers (which perform substantially the same function as the pitch and roll servo controllers 524, 526, 538, and 540, respectively) is substantially similar to that shown in FIG. 5 and described previously. In flight control system 700, however, the first and second pitch EMA controllers 724 and 726 are each connected to and in data communication with first and second left-hand elevator EMAs 728a and 728b, respectively, which operate the left-hand elevator 732. The first and second pitch EMA controllers 724 and 726 are also connected to and in data communication with first and second right-hand elevator EMAs 730a and 730b, respectively, which operate the right-hand elevator 734. Similarly, the first and second roll EMA controllers 738 and 740 are each connected to and in data communication with first and second left-hand aileron EMAs 742a and 742b, respectively, which operates the left-hand aileron 746. The first and second roll EMA controllers 738 and 740 are also connected to and in data communication with first and second right-hand aileron EMAs 744a and 744b, respectively, which operate the right-hand aileron 748.

In other embodiments utilizing a pair of EMAs for actuation of the primary control surfaces, there may be a dedicated EMA controller for each EMA. For example, there may be four pitch EMA controllers, one for each pitch EMA (742a-744b in the illustrated embodiment) connected to the elevators, wherein each pitch EMA controller is in communication with the FCCs. The same is true for roll control, where in some embodiments there may be a dedicated roll EMA controller for every roll EMA connected to the ailerons.

Rather than utilize a single dual-lane servo as in FIG. 5, the rudder 758 is controlled by a pair of rudder EMAs 756a and 756b, with each rudder EMA being connected to and in data communication with yaw EMA controllers 752 and 754, which perform a substantially identical function to yaw servo controllers 552 and 554.

Unlike the other control surfaces in the flight control system 700, the nose wheel steering system 760 does not utilize a pair of EMAs, nor does it share an EMA or servo with the rudder 758, as it does in the embodiment shown in FIG. 5. Instead, the nose wheel steering system 760 is operably connected to and controlled by a single EMA 762, which itself is connected to EMA controller 761, which is in data communication with the first and second FCCs 714 and 716, respectively. The nose wheel steering can be controlled by a single EMA path rather than a dual EMA path, because it is non-critical for flight control. However, in some embodiments it may be beneficial to implement a second EMA for controlling the nose wheel steering 760 in order to add additional redundancy to the system.

The flight control system 700 may also include one or more backup FCCs 764, which can provide additional redundancy to the system as a safeguard against failure. The additional FCC 764 may be connected to and in data communication with one or more of the various pitch, roll, or yaw EMA controllers in a similar fashion to primary FCCs 714, 716, and 718.

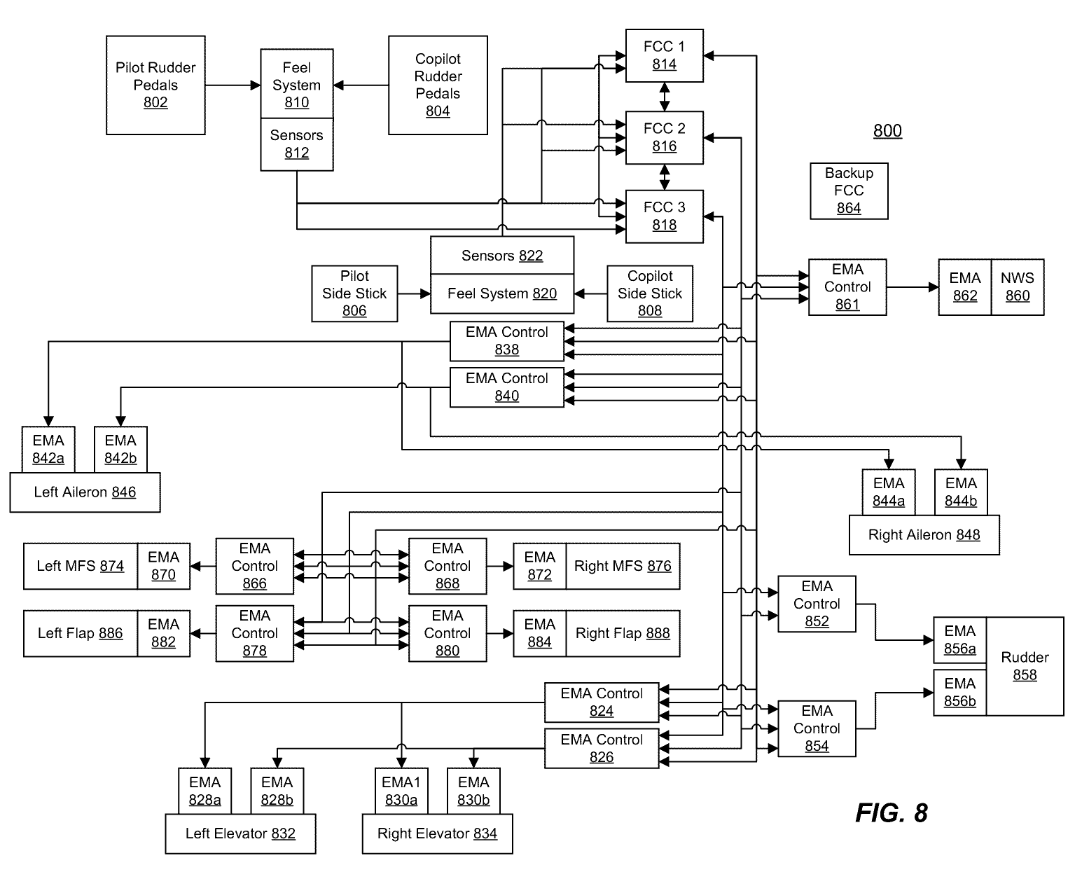

Turning now to FIG. 8; the flight control system 800 is substantially similar to flight control system 700 as shown and described above, albeit with additional control surfaces such as MFSs and flaps, similar to those shown in FIG. 6. For the sake of uniformity and brevity, reference numerals 800-899 correspond generally to the embodiment shown in FIG. 8, and correlate generally to reference numerals 700-799 (for example, pilot and copilot side sticks 806 and 808 correspond to pilot and copilot side sticks 706 and 708, left-hand aileron 846 corresponds generally to left-hand aileron 746, etc.), except where shown, described, or otherwise inherent.

In addition to the features shown and described in flight control system 700, flight control system 800 includes additional control surfaces as part of the FBW control path which perform functions beyond simply controlling the pitch, roll, and yaw of the aircraft, such as MFSs and flaps. For example, an operator may use MFSs for roll augmentation, in-flight drag devices, and/or as ground spoilers. Alternatively, an operator may deploy flaps for lift dumping or turbulence rejection.

Unlike the elevators 832 and 834, ailerons 846 and 848, and rudder 858, the MFSs and flaps may not necessarily employ dual EMA control, and instead may rely on single EMA control, similar to that disclosed above in reference to FIG. 6 and flight control system 600. For the MFSs, each FCC 814, 816, and 818 is connected to at least one MFS EMA controller 866 and 868. For redundancy purposes, each FCC 814-818 is in data communication with both MFS EMA controllers 866 and 868. Therefore, if one of the FCCs fails, there is still at least one FCC in data communication with each MFS EMA controller. Those of skill in the art will appreciate that in other embodiments not shown, various other combinations of connections between FCCs 814-818 and various EMA controllers may be employed without departing from the scope of the invention.

The first MFS EMA controller 866 is in data communication with a first MFS EMA 870, and the second MFS EMA controller 868 is connected to and in data communication with a second MFS EMA 872. The first MFS EMA 870 is operably connected to a left hand MFS 874, and the second MFS EMA is connected to a right hand MFS 876. Each MFS EMA 870, 872 is configured to move the left or right hand MFS 874 or 876 in response to receiving a signal from the first or second MFS EMA controller 866 or 868, each of which receives a signal from at least two of the FCCs 814-818 in response to an operator input.

Similar to the FBW MFSs, the flight control system 800 may further include FBW flaps, which may include mechanical interconnects prevent asymmetry in deployment. Each of the FCCs 814, 816, and 818 may be connected to and in data communication with at least one of two flap EMA controllers 878 and 880. Again, for redundancy purposes, each FCC 814-818 is in data communication with both the first flap EMA controller 878 and the second flap EMA controller 880. The first flap EMA controller 878 is in data communication with and connected to a first flap EMA 882, while the second flap EMA controller 880 is in data communication with and connected to a second flap EMA 884. The first flap EMA 882 is then operably connected to the left-hand flap 886 and the second flap EMA 884 is operably connected to the right-hand flap 888. Upon receiving a signal from the sensors 812 or 822 in response to an input from an operator (via the operator input controls or otherwise), the FCCs 814-818 send a signal to the flap EMA controller 878 and 880, which then adjust the left-hand or right-hand flaps 886 and/or 888 via the EMAs 882 and 884.

Although the invention has been described with reference to the embodiments shown in the attached drawing figures, it is noted that the equivalents may be employed and substitutions made herein without departing from the scope of the invention as recited in the claims.

Having thus described various embodiments of the invention, what is claimed as new and desired to be protected by Letters Patent includes the following:

1. A flight control system for an aircraft having a plurality of aerodynamic control surfaces, the system comprising:
a first and second operator input means configured to receive a mechanical input from an aircraft operator and being connected to an artificial feel system and at least one sensor;
a flight control computing system comprising a first, a second, and a third flight control computer, each flight control computer being in data communication with the sensor, wherein the computing system receives a signal from at least one sensor in response to an input by the operator;
a first servo controller in data communication with a first servo and the flight control computing system, the first servo being operably connected to a first aerodynamic control surface that, when moved, causes the aircraft to change attitude in a first degree of freedom;
a second servo controller in data communication with a second servo and the flight control computing system, the second servo being operably connected to a second aerodynamic control surface that, when moved, causes the aircraft to change attitude in a second degree of freedom; and
a third servo controller and a fourth servo controller, the third servo controller and the fourth servo controller being in data communication with a dual-lane servo operably connected to a third aerodynamic control surface that, when moved, causes the aircraft to change attitude in a third degree of freedom.

2. The flight control system of claim 1, wherein the dual-lane servo is connected to a nose wheel steering assembly.

3. The flight control system of claim 1, further comprising a first EMA controller in data communication with a first EMA operably connected to a fourth aerodynamic control surface that, when moved, causes the aircraft to change attitude in the first degree of freedom.

4. The flight control system of claim 3, further comprising a second EMA controller in data communication with a second EMA operably connected to a fifth aerodynamic control surface that, when moved, causes the aircraft to change attitude in the first degree of freedom.

5. A flight control system for an aircraft having a plurality of aerodynamic control surfaces, the system comprising:
an operator input means configured to receive a mechanical input from an aircraft operator and being connected to at least one sensor;
a flight control computing system comprising a first, a second, and a third flight control computer, each flight control computer being in data communication with the at least one sensor, wherein the computing system receives a signal from the at least one sensor in response to an input by the operator;
a first EMA controller in data communication with a first EMA and the flight control computing system, the first EMA being operably connected to at least a first portion of a first aerodynamic control surface that, when moved by the first EMA, causes the aircraft to change attitude in a first degree of freedom; and
a second EMA controller in data communication with a second EMA and the flight control computing system, the second EMA being operably connected to at least a first portion of a second aerodynamic control surface that, when moved by the second EMA, causes the aircraft to change attitude in a second degree of freedom.

6. The system of claim 5, further comprising a third EMA, the third EMA being in data communication with the first EMA controller and being operably connected to a second portion of the first aerodynamic control surface.

7. The system of claim 6, further comprising a fourth EMA, the fourth EMA being in data communication with the second EMA controller and being operably connected to a second portion of the second aerodynamic control surface.

8. The system of claim 5, further comprising a third EMA controller in data communication with a third EMA and the flight control computing system, the third EMA being operably connected to a second portion of the first aerodynamic control surface.

9. The system of claim 8, further comprising a fourth EMA controller in data communication with a fourth EMA and the flight control computing system, the fourth EMA being operably connected to a second portion of the second aerodynamic control surface.

10. The system of claim 5, further comprising:
a second operator input means configured to receive a mechanical input from an aircraft operator and being connected to at least one sensor and an artificial feel system, the sensor being in data communication with the flight control computing system; and
a third EMA controller in data communication with a third EMA and the flight control computing system, the third EMA being operably connected to a third aerodynamic control surface that, when moved by the second EMA, causes the aircraft to change attitude in a third degree of freedom.

11. The system of claim 7, further comprising:
a second operator input means configured to receive a mechanical input from an aircraft operator and being connected to at least one sensor and an artificial feel system, the sensor being in data communication with the flight control computing system; and
a fifth and sixth EMA, each being in data communication with a third EMA controller and each being operably connected to a third aerodynamic control surface that, when moved in response to an operator input via the second operator input means, causes the aircraft to change attitude in a third degree of freedom.

12. A flight control system for an aircraft having a plurality of aerodynamic control surfaces, the flight control system comprising:
an operator input means configured to receive a mechanical input from an aircraft operator and being connected to at least one sensor;
a flight control computing system comprising a first and a second flight control computer, each flight control computer being in data communication with the sensor, wherein the computing system receives a signal from the at least one sensor in response to an input by the operator;
a first aerodynamic control surface that, when moved, causes the aircraft to change attitude in a first degree of freedom, the first aerodynamic control surface being selectively connected to the operator input means via a first mechanical linkage;
a second aerodynamic control surface that, when moved, causes the aircraft to change attitude in a second degree of freedom, the second aerodynamic control surface being selectively connected to the operator input means via a second mechanical linkage;
a first servo controller in data communication with the flight control computing system and a first servo operably connected to the first aerodynamic control surface, the first servo being configured to selectively move the first aerodynamic control surface in response to a signal from the flight control computing system via the first servo controller; and
a latch-up mechanism configured to selectively engage at least one of the first mechanical linkage and the second mechanical linkage in response to an operator input.

13. The system of claim 12, further comprising a second servo controller in data communication with the flight control computing system and a second servo operably connected to the second aerodynamic control surface, the second servo being configured to selectively move the second aerodynamic control surface in response to a signal from the flight control computing system via the second servo controller.

14. The system of claim 12, further comprising a second servo controller in data communication with the flight control computing system and a second servo operably connected to the first aerodynamic control surface, the second servo being configured to selectively move the second aerodynamic control surface in response to a signal from the flight control computing system via the second servo controller.

15. The system of claim 13, further comprising a second servo controller in data communication with the flight control computing system and a second servo operably connected to the latch-up mechanism, the second servo being configured to operate the latch-up mechanism in response to a signal from the flight control computing system via the second servo controller.

16. The system of claim 12, wherein the latch-up mechanism has an engaged state and a disengaged state, and the latch-up mechanism is biased toward the engaged state by a biasing member.

17. The system of claim 12, further comprising:
a second operator input means configured to receive a mechanical input from an aircraft operator and being connected to at least one sensor and an artificial feel system, the sensor being in data communication with the flight control computing system;
a third aerodynamic control surface that, when moved, causes the aircraft to change attitude in a third degree of freedom; and
first and second EMA controllers, each EMA controller being in data communication with the flight control computing system and a dual-lane servo operably connected to the third aerodynamic control surface and configured to move the third aerodynamic control surface in response to an operator input via the second operator input means.

18. The system of claim 12, wherein the first servo is a dual-lane servo, and the system further includes a third servo controller in data communication with the first servo and the flight control computing system.

19. The system of claim 12, further comprising an EMA controller, the EMA controller being in data communication with the flight control computing system and an EMA operably connected to a third aerodynamic control surface that, when moved, causes the aircraft to change attitude in the first degree of freedom.

20. The system of claim 12, wherein at least one of the first aerodynamic control surface and the second aerodynamic control surface includes a trim tab connected to the operator input means via a mechanical linkage.
